(19) United States
(12) Patent Application Publication
(10) Pub. No.: US 2009/0152083 A1
(43) Pub. Date: Jun. 18, 2009

(54) KEYPAD ASSEMBLY FOR ELECTRONIC DEVICE

(75) Inventors: CHIH-WEI CHENG, Tu-Cheng (TW); KUO-HENG SUN, Tu-Cheng (TW); PAO-CHING MAO, Tu-Cheng (TW); CHIEN-CHIH KUO, Tu-Cheng (TW); CHI-CHANG CHENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/173,898

(22) Filed: Jul. 16, 2008

(30) Foreign Application Priority Data
Dec. 14, 2007 (CN) 200710203076.4

(51) Int. Cl. H01H 9/00

(52) U.S. Cl. 200/314

(57) ABSTRACT

A keypad assembly (100) includes a first soft layer (10), a stiff layer (20) mounted to the first soft layer, an optical layer (40) located under the stiff layer, and a second soft layer (50) mounted to the optical layer. The first soft layer has at least one protrusion (112) formed thereon. The stiff layer has at least one icon (222) formed thereon. The at least one icon corresponds to the at least one protrusion. The optical layer has at least one focusing unit (42) formed thereon. The at least one focusing unit corresponds to the at least one icon. The second soft layer has at least one switch point (522). The at least one switch point corresponds to the at least one protrusion.

### BACKGROUND OF THE INVENTION

1. Field of the Invention

The present invention generally relates to keypad assemblies, specifically to keypad assemblies of electronic devices, such as mobile phones.

2. Description of Related Art

With the development of wireless communication and information processing technologies, electronic devices, such as mobile telephones and electronic notebooks, are now in widespread use. These electronic devices enable consumers to enjoy high technology services, anytime and anywhere. A keypad assembly of an input terminal is an indispensable member of many electronic devices.

A typical keypad assembly for a given electronic device includes an upper shell and a keypad board. The upper shell defines a plurality of holes therethrough. The keypad board is formed with a plurality of keys on a top surface thereof and a plurality of switch points on a bottom surface thereof. Each switch point corresponds to a key. The keypad board is mounted under the upper shell and each key is exposed through a corresponding hole of the upper shell. However, the keys of the keypad board are typically made of stiff material and the switch points are made of metal. When a user presses the key, a finger of the user may feel uncomfortable due to the hard key and switch point.

Therefore, a new keypad assembly is desired.

### BRIEF DESCRIPTION OF THE DRAWINGS

Many aspects of the present keypad assembly can be better understood with reference to the following drawings. The components in the drawings are not necessarily drawn to scale, the emphasis instead being placed upon clearly illustrating the principles of the present keypad assembly. Moreover, in the drawings, like reference numerals designate corresponding parts throughout the several views.

FIG. 1 is an assembled, isometric view of a keypad assembly, in accordance with an exemplary embodiment.

FIG. 2 is an explored, isometric view of the keypad assembly shown in FIG. 1.

FIG. 3 is similar to FIG. 1, but viewed from another aspect.

### DETAILED DESCRIPTION OF THE EMBODIMENTS

The present keypad assembly is suitable for electronic devices, such as mobile phones, PDAs (personal digital assistants), and the like. Other applications with a similar use for the keypad assembly employed can also be found.

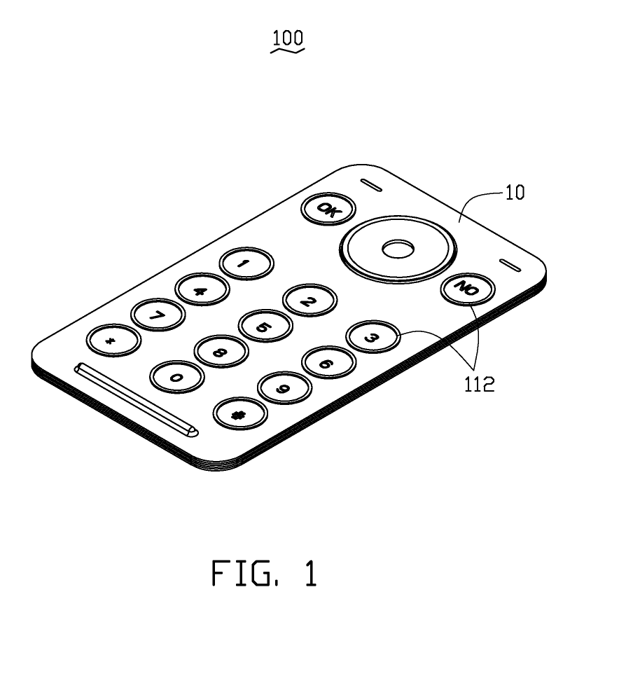

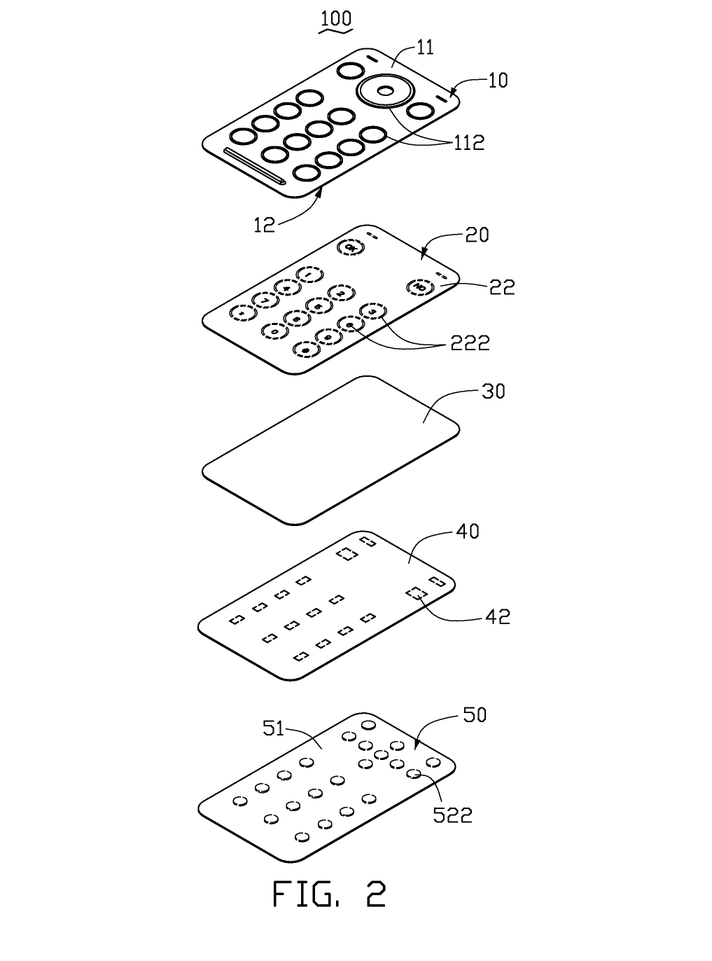

Referring to FIGS. 1 and 2, a keypad assembly 100 includes a first soft layer 10, a stiff layer 20 mounted to the first soft layer 10, an adhesive layer 30, an optical layer 40, and a second soft layer 50 mounted to the optical layer 40. The adhesive layer 30 interconnects the stiff layer 20 and the optical layer 40 together.

The first soft layer 10 is made of a transparent and elastic macromolecule material such as rubber, thermoplastic polyurethane and so on. A thickness of the first soft layer 10 is in the range of about 0.1-0.2 mm (millimeter), for example, about 0.2 mm. The first soft layer 10 has a top surface 11 formed with a plurality of protrusions 112 thereon and a bottom surface 12. The protrusions 112 of the first soft layer 10 are substantially ring-shaped. A thickness of the protrusion 112 is in the range of about 0.2-0.3 mm, for example, about 0.2 mm.

The stiff layer 20 has a printed layer 22 formed at one surface thereof. The printed layer 22 contacts the bottom surface 12 of the first soft layer 10 after the stiff layer 20 is assembled to the first soft layer 10. The printed layer 22 has a plurality of icons 222 formed thereon. In this exemplary embodiment, the printed layer 22 has a background color printed or applied thereon and the icons 222 are printed on or applied thereto in a contrasting color. Each icon 222 corresponds to a protrusion 112. The stiff layer 20 is made of a transparent, thermoplastic, and elastic macromolecule material such as polycarbonate, polyethylene terephathalate and so on. A thickness of the stiff layer 20 is in the range of about 0.1-0.2 mm, for example, about 0.125 mm. A thickness of the adhesive layer 30 is in the range of about 0.1-0.2 mm, for example, about 0.1 mm.

The optical layer 40 has a plurality of focusing units 42 formed thereon. Each focusing unit 42 corresponds to an icon 222 of the stiff layer 20 and is configured (structured and arranged) for focusing the light travelling therethrough. The optical layer 40 is made of a transparent and plastic macromolecule material such as polyimide and so on. A thickness of the optical layer 40 is in the range of about 0.1-0.2 mm, for example, about 0.125 mm.

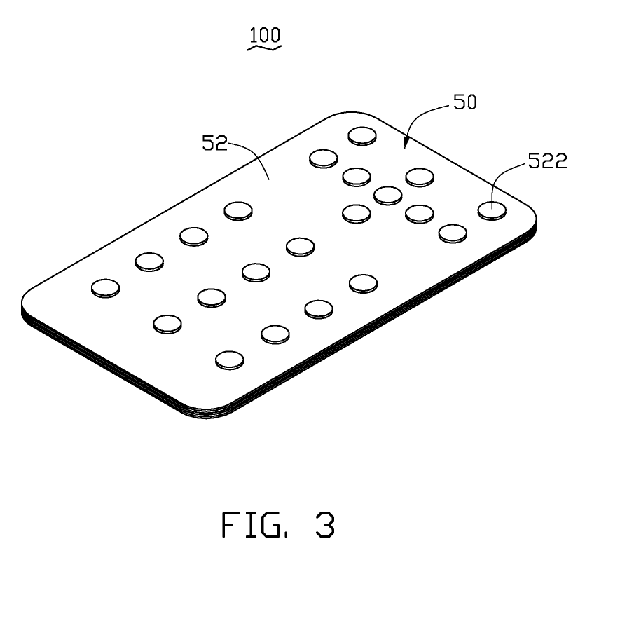

Also referring to FIG. 3, the second soft layer 50 is made of a transparent and elastic macromolecule material such as rubber, thermoplastic polyurethane and so on. A thickness of the second soft layer 50 is in the range of about 0.05-0.1 mm, for example, about 0.125 mm. The second soft layer 50 has a bottom surface 52 with a plurality of switch points 522 formed thereon and a top surface 51. Each switch point 522 corresponds to a protrusion 112 of the first soft layer 10 and a contact position on a circuit board (not shown). Each switch point 522 is substantially cylindrical in shape. A thickness of each switch point 522 is in the range of about 0.2-0.3 mm, for example, about 0.25 mm.

It should be understood that the icons 222 may be formed on the bottom surface 12 of the first soft layer 10.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A keypad assembly comprising:
a first soft layer having at least one protrusion formed thereon;
a stiff layer mounted to the first soft layer and having at least one icon formed thereon, the at least one icon corresponding to the at least one protrusion;
an optical layer located under the stiff layer and having at least one focusing unit formed thereon, the at least one focusing unit corresponding to the at least one icon; and
a second soft layer mounted to the optical layer and having at least one switch point, the at least one switch point corresponding to the at least one protrusion.

2. The keypad assembly as claimed in claim 1, further comprising an adhesive layer interconnecting the stiff layer and the optical layer together.

3. The keypad assembly as claimed in claim 2, wherein a thickness of one of the first soft layer, the stiff layer, the adhesive layer, and the optical layer is in the range of about 0.1-0.2 mm.

4. The keypad assembly as claimed in claim 1, wherein the first soft layer has a top surface formed with the at least one protrusion and a bottom surface.

5. The keypad assembly as claimed in claim 4, wherein the stiff layer has a printed layer formed with the at least one icon, the printed layer contacting the bottom surface of the first soft layer.

6. The keypad assembly as claimed in claim 1, wherein one of the first soft layer and the second soft layer is made of a transparent and elastic macromolecule material.

7. The keypad assembly as claimed in claim 6, wherein one of the first soft layer and the second soft layer is made of a material selected from a group consisting of rubber and thermoplastic polyurethane.

8. The keypad assembly as claimed in claim 1, wherein the protrusion of the first soft layer is substantially ring-shaped.

9. The keypad assembly as claimed in claim 1, wherein a thickness of the at least one protrusion of the first soft layer is in the range of about 0.2-0.3 mm.

10. The keypad assembly as claimed in claim 1, wherein the stiff layer is made of a transparent, thermoplastic, and elastic macromolecule material.

11. The keypad assembly as claimed in claim 1, wherein the stiff layer is made of a material selected from a group consisting of polycarbonate and polyethylene terephathalate.

12. The keypad assembly as claimed in claim 1, wherein the optical layer is made of polyimide.

13. The keypad assembly as claimed in claim 1, wherein the at least one focusing unit is configured for focusing the light transmitted therethrough.

14. The keypad assembly as claimed in claim 1, wherein a thickness of the second soft layer is in the range of about 0.05-0.1 mm.

15. The keypad assembly as claimed in claim 1, wherein the at least one switch point of the second soft layer is substantially cylindrical in shape.

16. The keypad assembly as claimed in claim 1, wherein a thickness of the at least one switch point of the second soft layer is in the range of about 0.2-0.3 mm.

17. A keypad assembly comprising:
a first soft layer having at least one protrusion formed thereon;
a stiff layer mounted to the first soft layer, at least one icon formed between the first soft layer and the stiff layer and the at least one icon corresponding to the at least one protrusion;
an optical layer located under the stiff layer and having at least one focusing unit formed thereon, the at least one focusing unit corresponding to the at least one icon; and
a second soft layer mounted to the optical layer and having at least one switch point, the at least one switch point corresponding to the at least one protrusion.
